(19) United States
(12) Patent Application Publication
(10) Pub. No.: US 2020/0244058 A1
(43) Pub. Date: Jul. 30, 2020

(54) ORGANIZING COMBINATION FOR CABLE AND WIRE

(71) Applicant: Wanho T Manufacturing Co., Ltd., Ilan (TW)

(72) Inventors: Christopher Pierre CROUNSE, Florence, AZ (US); Arthur C. Gagnon, Wolcott, CT (US); David Robert Elliott, Southington, CT (US)

(21) Appl. No.: 16/257,138

(22) Filed: Jan. 25, 2019

(51) Int. Cl. H02G 3/32; F16L 3/10; F16L 3/23

(52) U.S. Cl. CPC H02G 3/32; F16L 3/23; F16L 3/1091

(57) ABSTRACT

An organizing device includes a support member having two limbs, and a lock member formed on each of the limbs, the lock members are engageable with each other for forming a compartment between the limbs and in the support member, and a retainer member is engaged in the compartment of the limbs of the support member, and the retainer member includes a groove for engaging with a wire or a cable. The support member includes a hand grip formed on each of the limbs for actuating the lock members to be engaged with each other and to be disengaged from each other and for allowing the lock members of the limbs to be easily and effectively actuated or operated by the users.

### BACKGROUND OF THE INVENTION

### 1. Field of the Invention

The present invention relates to a cable and wire organizing combination, and more particularly to a cable and wire organizing combination including a structure or configuration for allowing the cables and the wires to be easily and quickly wrapped or bundled and organized and to be easily and quickly attached or mounted or secured to various supporting facilities with the organizing combination.

### 2. Description of the Prior Art

Typical cable organizing combinations comprise a back mounting block for attaching or mounting or securing to various supporting apparatuses or facilities, the back mounting block includes a number of slots formed therein for receiving or engaging with the cables and the wires, and a front cap attached or mounted or secured to the back mounting block for clamping and retaining the cables and the wires between the back mounting block and the front cap. For allowing the cables and the wires to be easily and quickly wrapped or bundled and organized, various kinds of cable and wire organizing devices have been developed and provided for organizing the cables and the wires.

For example, U.S. Pat. No. 9,438,021 B2 to Crounse et al., and U.S. Pat. No. 10,094,491 B1 to Crounse et al. disclose several of the typical cable organizing devices each comprising a bracket or organizing member for clamping and retaining the cables and the wires together.

However, the organizing member may only be used for clamping and retaining the cables and the wires together, but may not be used for attaching or mounting or securing the cables and the wires to various supporting facilities.

The present invention has arisen to mitigate and/or obviate the afore-described disadvantages of the conventional cable and wire organizing devices.

### SUMMARY OF THE INVENTION

The primary objective of the present invention is to provide a cable organizing combination including a structure or configuration for allowing the cables and the wires to be easily and quickly wrapped or bundled and organized and to be easily and quickly attached or mounted or secured to various supporting facilities with the organizing combination.

In accordance with one aspect of the invention, there is provided an organizing combination comprising a support member including two limbs extended from the support member, and a lock member formed on each of the limbs, the lock members being engageable with each other for forming a compartment between the limbs and in the support member, and a retainer member received and engaged in the compartment of the limbs of the support member, and the retainer member including a groove formed in the retainer member for receiving and engaging with a cable or wire, and for allowing the cable or the wire to be easily and quickly wrapped or bundled and organized and to be easily and quickly attached or mounted or secured to various supporting facilities with the organizing combination.

The support member includes a hand grip formed on each of the limbs for actuating the lock members to be engaged with each other and to be disengaged from each other. The hand grips each include a serrated surface formed or provided thereon for increasing the roughness or friction of the hand grips and for allowing the hand grips to be easily and effectively actuated or operated by the users. The hand grips are located close to the respective lock member for operating the lock members.

The limbs are extended upwardly from the support member, and the lock members are formed on a free end portion of each of the limbs. The lock member of one of the limbs is selected from a female hook member, and the lock member of another limb is selected from a male hook member for selectively engaging with the female hook member.

A clamping member may further be provided and engaged with the support member for attaching the support member to a supporting object. The support member includes two openings formed in the support member, and the clamping member includes two buckle members formed at end portions for engaging with the openings of the support member and for engaging with each other and thus for attaching or mounting or securing the support member to various supporting objects or facilities. The support member includes two extensions extended from the support member, and the openings are formed in the extensions respectively for receiving and engaging with the buckle members of the clamping member selectively.

The retainer member includes a slot formed in the retainer member and communicating with the groove of the retainer member. The retainer member includes a partition formed in the retainer member. The retainer member includes a flange for engaging with the limbs of the support member.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial exploded view of a cable organizing combination in accordance with the present invention;

FIG. 2 is a perspective view of the cable organizing combination;

FIG. 3 is a cross sectional view of the cable organizing combination, taken along lines 3-3 of FIG. 2;

FIG. 4 is another cross sectional view similar to FIG. 3, illustrating the operation of the cable organizing combination;

FIG. 5 is another partial exploded view illustrating the operation of the cable organizing combination;

FIG. 6 is a partial perspective view illustrating one of the arrangements of the cable organizing combination; and

FIGS. 7, 8, 9 are other partial perspective views similar to FIG. 6, illustrating the other arrangements of the cable organizing combination.

### DETAILED DESCRIPTION OF THE PREFERRED EMBODIMENT

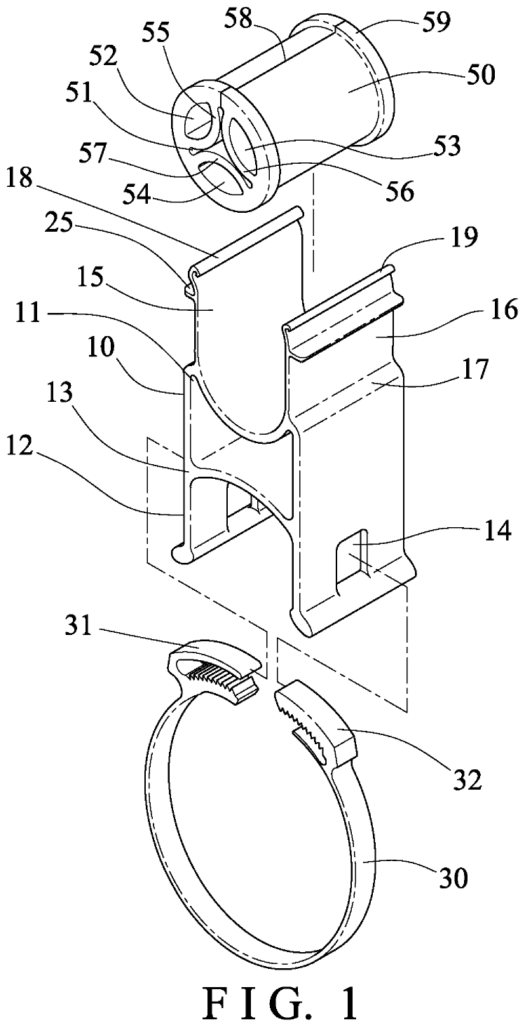

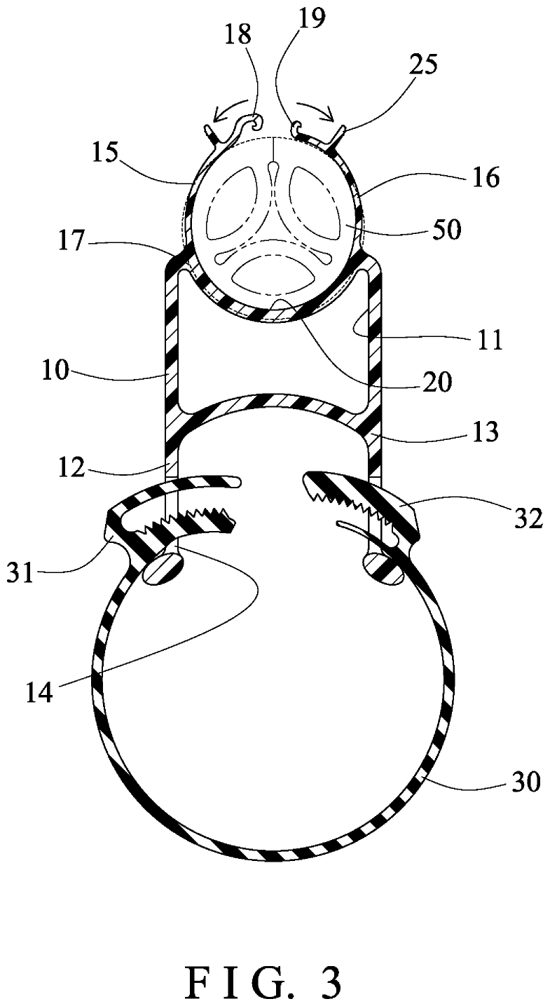

Referring to the drawings, and initially to FIGS. 1-4, a cable organizing combination in accordance with the present invention comprises a holder body or housing or support member 10 made of soft or resilient rubber or plastic or composite materials, the support member 10 may include one or more openings or compartments or chambers 11 formed therein for weight reducing purposes, or for increasing the resilience or the like for the support member 10. The support member 10 includes one or more (such as two) legs or extensions 12 extended downwardly therefrom, such as extended downwardly from the lower or bottom portion 13 of the support member 10, and preferable, but not necessary that the extensions 12 are parallel to each other.

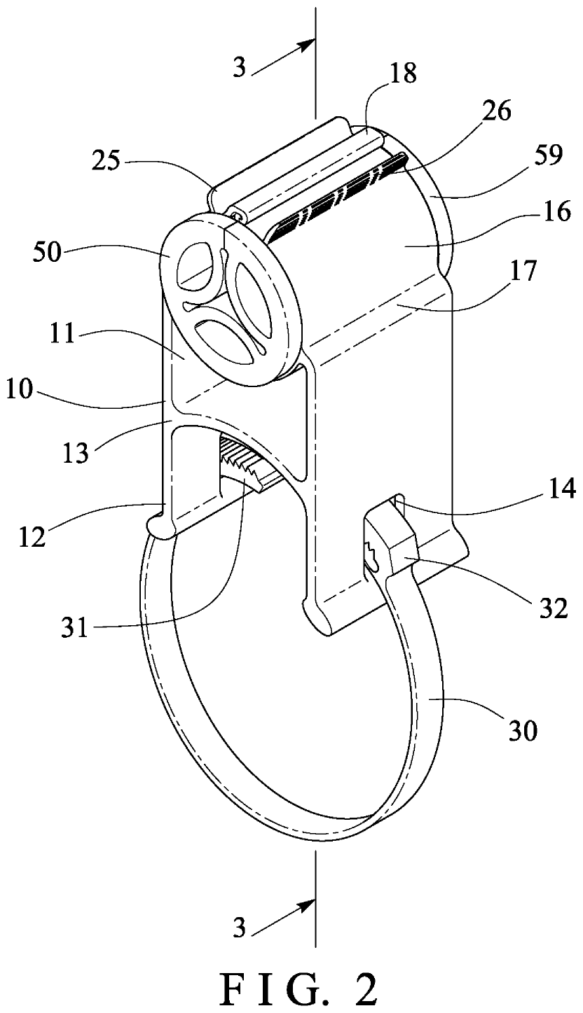

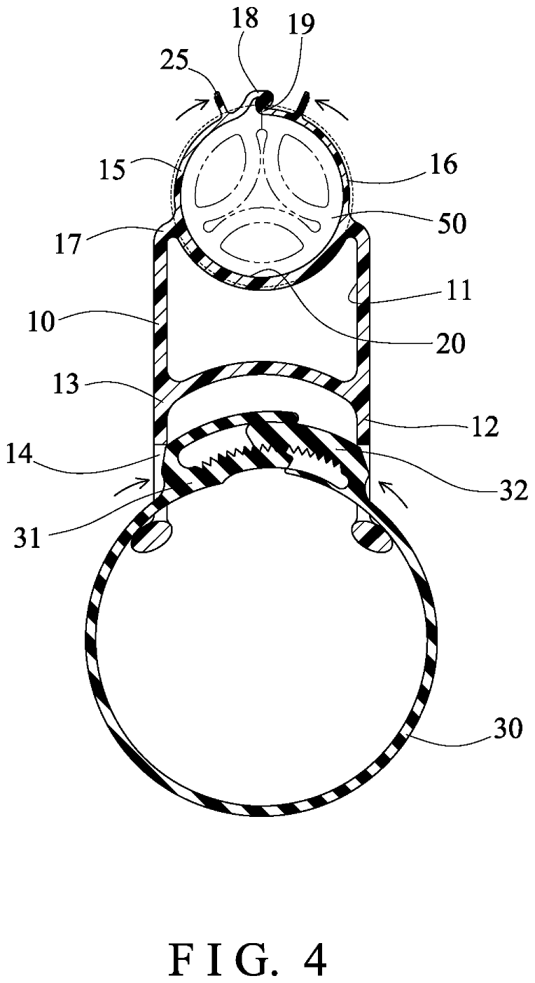

A retaining or clamping ring or strap or member 30 is provided for engaging with the support member 10 and for attaching or mounting or securing the support member 10 to various supporting objects or facilities (not illustrated), such as tubes, columns, rods, posts, poles, legs or the like. For example, the support member 10 includes an orifice or opening 14 formed in each of the extensions 12, and the clamping member 30 includes two lock members or buckle members 31, 32 formed or provided at the two end portions thereof for engaging into or through the openings 14 of the extensions 12 (FIG. 2), and for engaging with each other (FIG. 4) and thus for attaching or mounting or securing the support member 10 to various supporting objects or facilities.

The support member 10 further includes one or more (such as two) legs or arms or limbs 15, 16 extended upwardly therefrom, such as extended upwardly from the upper portion 17 of the support member 10, and a buckle or hook or retainer or lock member 18, 19 formed or provided at the upper or free end portion of each of the limbs 15, 16, and arranged for allowing the lock members 18, 19 to be engaged with each other (FIGS. 2, 4) and for forming or defining a space or chamber or compartment 20 between the limbs 15, 16, and/or at or in the upper portion 17 of the support member 10, and for receiving or engaging with a cylindrical retainer body or member 50. For example, the lock member 18 of one of the limbs 15 may be selected from a male or female hook or lock member 18 for selectively engaging with the other lock member 19 of the other limb 16 that may be selected from a female or male hook or lock member 19.

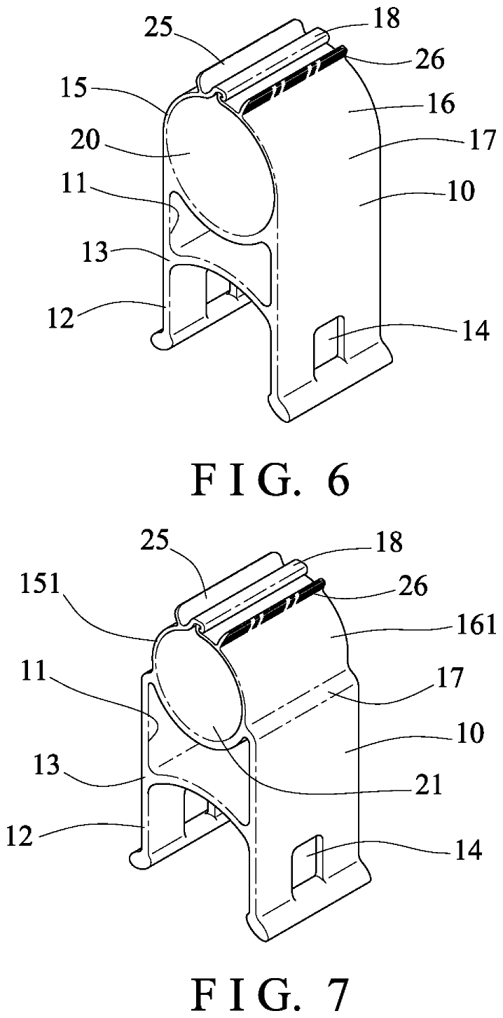

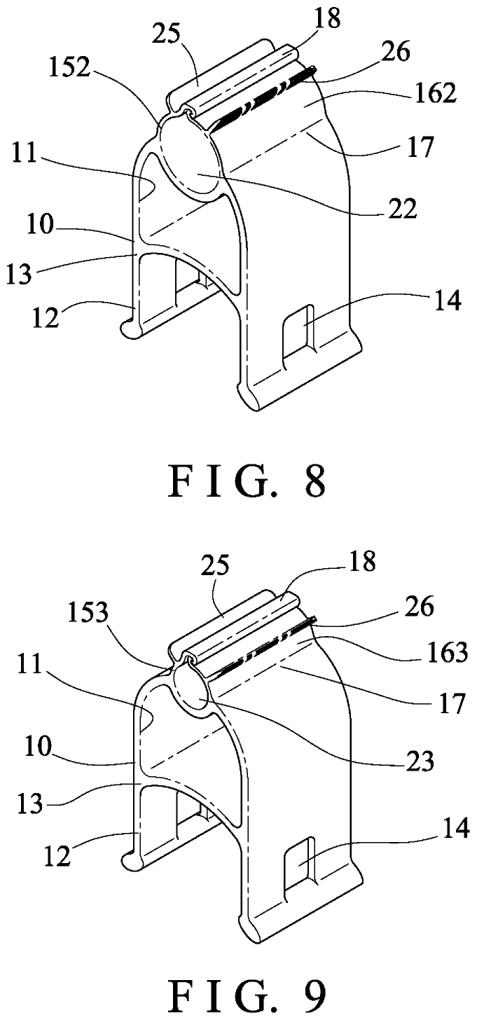

As shown in FIGS. 6-9, the limbs 15, 16; 151, 161; 152, 162; 153, 163 may include a length or height or dimension or size different from each other for forming or defining the compartment 20, 21, 22, 23 of different sizes or dimensions or diameters and for receiving or engaging with the cylindrical retainer members 50 of different sizes or dimensions or diameters. It is preferable, but not necessary that the support member 10 further includes a knob or handle or hand grip 25 formed or provided at the upper or free end portion of each of the limbs 15, 16, and arranged or disposed or located close to the respective lock member 18, 19, for actuating or operating the lock members 18, 19, and for forcing the lock members 18, 19 to be engaged with each other and/or to be disengaged from each other.

It is further preferable, but not necessary that the hand grips 25 of the limbs 15, 16 each include a rough or coarse or uneven or serrated surface 26 (FIGS. 2 and 6-9) formed or provided thereon for increasing the roughness or friction of the hand grips 25 and arranged for allowing the hand grips 25 to be easily and effectively actuated or operated by the users. The support member 10, at least the limbs 15, 16 at the upper portion 17 of the support member 10 are made of soft or resilient rubber or plastic or composite materials for increasing the softness or spring or resilience of the limbs 15, 16 of the support member 10, and for allowing the limbs 15, 16 to be suitably deformed or folded, and thus for allowing the lock members 18, 19 to be easily engaged with each other and/or to be easily disengaged from each other.

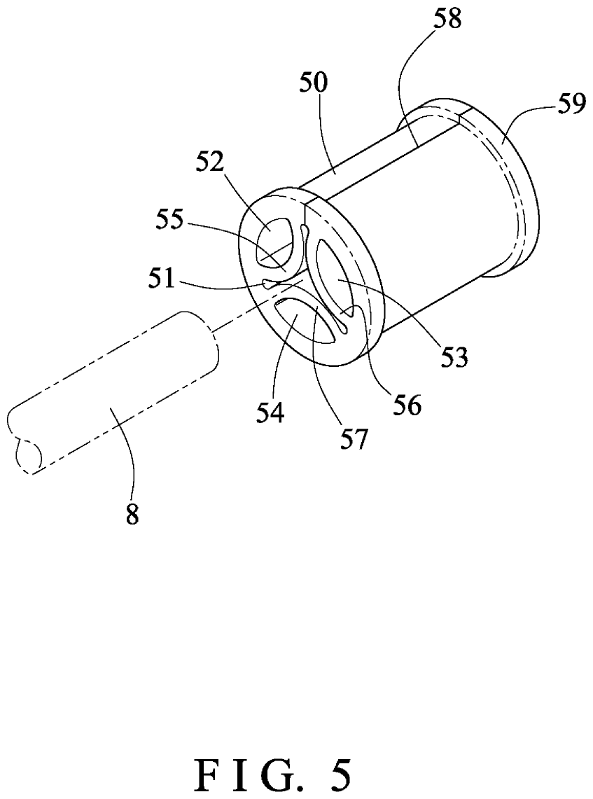

As shown in FIGS. 1-5, the cylindrical retainer member 50 includes one or more channels or grooves 51, 52, 53, 54 formed therein and separated or spaced from each other, for receiving or engaging with the cables and/or the wires 8 (FIG. 5), for example, the middle or intermediate or central or first groove 51 of the cylindrical retainer member 50 includes a dimension or size or standard or shape or contour, such as a substantially triangular structure different from that of the other grooves 52, 53, 54, such as a substantially oval or elliptical shape or contour or structure, and the middle or intermediate or central or first groove 51 of the cylindrical retainer member 50 is located within or between or among the other grooves 52, 53, 54 of the cylindrical retainer member 50 for forming or defining a flexible rib or flap or partition 55, 56, 57 between or among the adjacent grooves 51, 52, 53, 54 of the cylindrical retainer member 50.

The cylindrical retainer member 50 also includes one or more slots 58 formed in the outer peripheral portion thereof and intersecting or communicative with either of the grooves 51 for allowing the cables and/or the wires 8 to be easily and quickly engaged through the slot 58 and then engaged into the groove 51 of the cylindrical retainer member 50 of the organizing combination. The cylindrical retainer member 50 further includes two end peripheral flanges 59 for engaging with the limbs 15, 16 of the support member 10 and for solidly and stably anchoring or securing or retaining the cylindrical retainer member 50 to the limbs 15, 16 of the support member 10, and for preventing the cylindrical retainer member 50 from being disengaged from the limbs 15, 16 of the support member 10.

In operation, as shown in FIG. 5, the cable or wire 8 may be engaged into or through the slot 58 of the retainer member 50 and into the groove 51 of the retainer member 50, and the retainer member 50 may then be engaged into the compartment 20 that is formed or provided or defined between the limbs 15, 16, and/or at or in the upper portion 17 of the support member 10 (FIGS. 1, 2), and the lock members 18, 19 of the limbs 15, 16 may then be easily forced to engage with each other in order to solidly and stably anchor or secure or retain the retainer member 50 to the limbs 15, 16 of the support member 10 (FIGS. 2-4), and for preventing the retainer member 50 from being disengaged from the limbs 15, 16 of the support member 10.

As also shown in FIGS. 2-4, the buckle members 31, 32 of the clamping member 30 may then be engaged with the support member 10, for example, the buckle members 31, 32 may be engaged into or through the openings 14 of the extensions 12, and then engaged with each other (FIG. 4) for attaching or mounting or securing the support member 10 to various supporting objects or facilities (not illustrated).

Accordingly, the cable organizing combination includes a structure or configuration for allowing the cables and the wires to be easily and quickly wrapped or bundled and organized and to be easily and quickly attached or mounted or secured to various supporting facilities with the organizing combination.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

1-12. (canceled)

13. An organizing combination comprising:
a retainer member including a first groove formed in said retainer member for receiving and engaging with a wire, and said retainer member including at least one second groove formed in said retainer member for forming a flexible partition in said retainer member and between said first groove and said at least one second groove and for engaging with the wire, and for retaining the wire in said retainer member.

14. The organizing combination as claimed in claim 13, wherein said retainer member includes a slot formed in said retainer member and communicating with said first groove of said retainer member.

15. The organizing combination as claimed in claim 13 further comprising a support member including two limbs, and a lock member formed on each of said limbs, said lock members being engageable with each other for forming a compartment between said limbs and in said support member, and said retainer member being received and engaged in said compartment of said limbs of said support member.

16. The organizing combination as claimed in claim 15, wherein said support member includes a hand grip formed on each of said limbs for actuating said lock members to be engaged with each other and to be disengaged from each other.

17. The organizing combination as claimed in claim 15, wherein said lock member of one of said limbs is selected from a female hook member, and said lock member of another limb is selected from a male hook member.

18. The organizing combination as claimed in claim 15 further comprising a clamping member engaged with said support member for attaching said support member to a supporting object.

19. The organizing combination as claimed in claim 18, wherein said support member includes two openings formed in said support member, and said clamping member includes two buckle members formed at end portions for engaging with said openings of said support member and for engaging with each other.

20. The organizing combination as claimed in claim 19, wherein said support member includes two extensions, and said openings are formed in said extensions respectively.

21. The organizing combination as claimed in claim 15, wherein said retainer member includes a flange for engaging with said limbs of said support member.
